(19) United States
(12) Patent Application Publication
(10) Pub. No.: US 2012/0059514 A1
(43) Pub. Date: Mar. 8, 2012

(54) ROBOT SYSTEM AND METHOD FOR CONTROLLING THE SAME

(75) Inventor: Young Ho SUH, Gwangju (KR)

(73) Assignee: Electronics and Telecommunications Research Institute, Daejon (KR)

(21) Appl. No.: 13/216,354

(22) Filed: Aug. 24, 2011

(30) Foreign Application Priority Data
Sep. 2, 2010 (KR) 10-2010-0086216
Apr. 12, 2011 (KR) 10-2011-0033658

(51) Int. Cl. B25J 13/00

(52) U.S. Cl. 700/245; 901/50

(57) ABSTRACT

Disclosed is a robot server including: a policy repository storing a collaboration policy model including a collaboration role of the robot and a command system configured of a simple command configured of a single command so as to perform the collaboration role and a composite command including at least one simple command; and a communication unit transmitting information on the collaboration role to be allocated to at least one robot and information on the simple command or the composite command to be allocated according to the collaboration role to the at least one robot.

### CROSS-REFERENCE TO RELATED APPLICATIONS

This application claims priority to and the benefit of Korean Patent Applications No. 10-2010-0086216 and NO. 10-2011-0033658 filed in the Korean Intellectual Property Office on Sep. 2, 2010 and Apr. 12, 2011, the entire contents of which are incorporated herein by reference.

### TECHNICAL FIELD

The present invention relates to definition of a collaboration policy model for collaborating a plurality of homogeneous/heterogeneous robots, a robot system using the same, and a method for controlling the same.

### BACKGROUND

A robot is an apparatus to perform specific functions in various fields, such as medical, aerospace, industrial, cleaning, or the like, according to any commands.

Recently, the robot is considered to be a multi-functional apparatus having mobility within ubiquitous environment. Apparatuses such as a sofa, a refrigerator, or the like, within the existing environment partially have a function of a robot and thus, have evolved to robotic apparatuses such as a robotic sofa, a robotic refrigerator. Within the ubiquitous environment, it may be difficult to interlock between heterogeneous robots when a plurality of heterogeneous robots have heterogeneous platforms, heterogeneous functions, heterogeneous systems, or different communication protocols.

In order to collaborate the plurality of heterogeneous robots, there is a need to understand specifications of various driving units and sensing devices that are included in the plurality of heterogeneous robots.

### SUMMARY

The present invention has been made in an effort to provide a robot system for providing a collaboration policy model represented by a role-based command transition diagram for interlocking between a plurality of heterogeneous robots and a method for controlling the same.

The present invention has been made in an effort to provide a robot system for providing a standard interface for interlocking between a plurality of heterogeneous robots and a method for controlling the same.

The present invention has been made in an effort to provide a robot system for understanding specifications of various driving units and sensing devices that are included in a plurality of heterogeneous robots, respectively, and a method for controlling the same.

The present invention has been made in an effort to provide a robot system for providing a control and scheduling algorithm for applications for collaborating a plurality of distributed heterogeneous robots and a method for controlling the same.

An exemplary embodiment of the present invention provides a robot server for controlling collaboration of at least one robot, including: a policy repository storing a collaboration policy model including a collaboration role of the robot and a command system configured of a simple command configured of a single command so as to perform the collaboration role and a composite command including at least one simple command; and a communication unit transmitting information on the collaboration role to be allocated to at least one robot and information on the simple command or the composite command to be allocated according to the collaboration role to the at least one robot.

The composite command may include at least one of: a first command allocating a sequence to at least two commands; a second command simultaneously performing at least two commands; a third command simultaneously performing a foreground command and a background command, and automatically forcibly canceling the background command when the foreground command is first ended; a fourth command performing a command only for a specified time-out time; and a fifth command performing a command after a specified delay time.

The collaboration policy model may further include a transition rule generating transition changing the collaboration role of command performance.

The robot server may further include a policy parser parsing the collaboration policy model stored in the policy repository.

The robot server may further include a policy factory generating a collaboration application based on the collaboration policy model parsed from the policy parser.

The robot server may further include a robot registry unit registering identifier information and standard apparatus list information each transmitted from the robot.

The robot server may further include a role registry unit registering at least one collaboration role modeled in the collaboration policy and at least one kind of command required for performing each collaboration role.

The robot server may further include an relay unitintermediary unit searching a standard apparatus to perform each collaboration role based on a plurality of robot identifier information and standard apparatus list information registered in the robot registry unit and at least one collaboration role registered in the role registering unit and generating a list of target robots to perform each collaboration role based on the search result.

The robot server may further include a command manager selecting a robot participating in the collaboration among the plurality of robots based on the list of the target robots to perform each collaboration role generated from the relay unitintermediary unit and generating a command object for controlling the selected robot.

Another exemplary embodiment of the present invention provides a robot controlled by collaboration control of a robot server, including: a communicating unit receiving corresponding role information on the collaboration and information a corresponding command related to a role for the collaboration that are generated based on a collaboration policy model including a collaboration role of the robot stored in the robot server and a command system configured of a simple command configured of a single command so as to perform the collaboration role and a composite command including at least one simple command; and a performing unit performing actions corresponding to the corresponding role and the corresponding command.

The performing unit may be a speaker when the corresponding command according to the corresponding role is a command for speech.

The performing unit may be a driver when the corresponding command according to the corresponding role is a command for movement.

The performing unit may be a display when the corresponding command according to the corresponding role is a command for image display.

The robot may further include a robot manager performing a control to transmit identifier information of the robot and standard apparatus list information of the robot to the robot server.

Yet another exemplary embodiment of the present invention provides a method for controlling at least one robot, including: receiving, from at least one robot used for a predetermined collaboration, identifier information of the robot and standard apparatus list information of the robot; extracting a corresponding role of the robot used for the predetermined collaboration and a command according to the corresponding role from a collaboration policy model; selecting a corresponding robot among the at least one robot based on the identifier information of the robot, the standard apparatus list information of the robot, the corresponding role of the robot, and the command according to the corresponding role; and transmitting information on the role of the robot and information on the command according to the role to the selected corresponding robot.

Still another exemplary embodiment of the present invention provides a method for controlling at least one robot, including: receiving corresponding role information on the collaboration and information a corresponding command related to a role for the collaboration that are generated based on a collaboration policy model including a collaboration role of the robot stored in the robot server and a command system configured of a simple command configured of a single command so as to perform the collaboration role and a composite command including at least one simple command; and performing actions corresponding to the corresponding role and the corresponding command.

The method may further include transmitting identifier information of the robot and standard apparatus list information of the robot to the robot server.

The exemplary embodiments of the present invention have the following advantageous.

First, the exemplary embodiments of the present invention can perform the collaboration function between the plurality of heterogeneous robots by providing the collaboration policy model represented by the role-based command transition diagram for interlocking the plurality of heterogeneous robots.

Second, the exemplary embodiments of the present invention can perform the control function and/or the data transmission function between the plurality of heterogeneous robots by providing the standard interface (or, the communication protocols) for interlocking between the plurality of heterogeneous robots.

Third, the exemplary embodiments of the present invention can easily create applications for collaboration by using each function of the plurality of robots and perform the collaboration applications by dynamically selecting and remotely controlling the robots distributed on the network as participants of collaboration based on the created collaboration policy, by understanding the specifications of various driving units and sensing devices that are included in the plurality of heterogeneous robots, respectively, and by providing the control and scheduling algorithm.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram of a robot system according to an exemplary embodiment of the present invention.

FIG. 2 is a diagram showing a standard interface according to an exemplary embodiment of the present invention.

FIG. 3 is a diagram showing a structure of a command according to an exemplary embodiment of the present invention.

FIG. 4 is a diagram showing an example of a composite command according to an exemplary embodiment of the present invention.

FIG. 5 is a diagram showing a collaboration policy model according to an exemplary embodiment of the present invention.

FIG. 6 is a diagram showing a flow chart showing a method for controlling a robot system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Exemplary embodiments of the present invention may be implemented by various units. For example, the exemplary embodiments of the present invention may be implemented by hardware, firmware, software, or a combination thereof, or the like.

In the case of the implementation by the hardware, a method according to the exemplary embodiments of the present invention may be implemented by at least one of application specific integrated circuits (ASICs), digital signal processors (DSPs), digital signal processing devices (DSPDs), programmable logic devices (PLDs), field programmable gate arrays (FPGAs), a processor, a controller, a microcontroller, a microprocessor, or the like.

In the implementation of the firmware or the software, the method according to the exemplary embodiments of the present invention may be implemented in a form of a module, a procedure, a function, or the like, that perform functions or operations described above. A software code may be stored in a memory unit and may be driven by a processor. The memory unit is disposed inside or outside the processor to transmit and receive data to and from the processor by the already known various units.

A case in which any one part is connected with the other part includes a case in which the parts are directly connected with each other and a case in which the parts are connected with each other with other elements interposed therebetween. Unless explicitly described to the contrary, the word “comprise” and variations such as “comprises” or “comprising”, will be understood to imply the inclusion of stated elements but not the exclusion of any other elements.

A term “module” described in the specification means a unit of processing at least one function or operation and can be implemented by hardware or software or a combination of hardware and software. The specific terms used in the following description are provided in order to help understanding of the present invention. The use of the specific terms may be changed into other forms without departing from the technical idea of the present invention.

The exemplary embodiments of the present invention relates to a robot system for providing a collaboration policy model represented by a role-based command transition diagram for interlocking between a plurality of heterogeneous robots and a method for controlling the same.

The exemplary embodiments of the present invention can perform a collaboration function between a plurality of heterogeneous robots by providing a collaboration policy model represented by a role-based command transition diagram for interlocking between a plurality of heterogeneous robots, perform a control function and/or a data transmission function between the plurality of heterogeneous robots by providing a standard interface for interlocking between the plurality of heterogeneous robots, and easily create applications for collaboration by using each function of the plurality of robots and perform the collaboration applications by dynamically selecting and remotely controlling the robots distributed on the network as participants of collaboration based on the created collaboration policy, by understanding the specifications of execution devices such as various drivers, or the like, that are included in the plurality of heterogeneous robots, respectively, and by providing the control and scheduling algorithm.

Hereinafter, exemplary embodiments of the present invention will be described in detail with reference to the accompanying drawings.

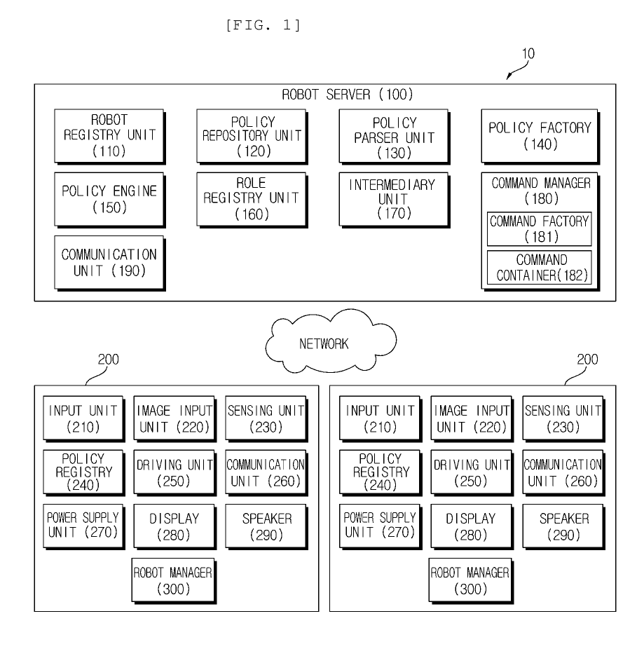

FIG. 1 is a configuration diagram of a robot system 10 according to an exemplary embodiment of the present invention.

The robot system 10 according to the exemplary embodiment of the present invention includes a robot server 100 and a plurality of robots 200.

As shown in FIG. 1, the robot server 100 according to the exemplary embodiment of the present invention includes a robot registry unit 110, a policy repository 120, a policy parser 130, a policy factory 140, a policy engine 150, a role registry unit 160, a mediation unit (match maker) 170, a command manager 180, and a communication unit 190.

When the robot registry unit 100 according to the exemplary embodiment of the present invention communicates with the plurality of robots 200, respectively, on a wired/wireless network through a communication unit 190. The robot registry unit 100 receives identifier information of the corresponding robot 200 transmitted from each robot 200 and standard apparatus list information of the corresponding robot 200 and registers the received identifier information and standard apparatus list information the corresponding robot 200. In this configuration, the standard apparatus, which is apparatuses included in the robot, may be an input unit, an image input unit, a sensing unit, a driving unit, a communication unit, a display, a speaker, or the like. In this configuration, the standard apparatus means an apparatus that may be driven according to a command of a robot server.

The policy repository 120 according to the exemplary embodiment of the present invention stores a general RPC (remote object function call) model based standard interface so as to provide a standardized platform between any heterogeneous/homogenous robots. That is, the policy repository 120 stores a common standard interface for role execution devices, such as driver, or the like, and sensing devices that are included in the platforms of any heterogeneous or homogeneous robots that are defined by the robot server 100.

Meanwhile, the standard interface according to the exemplary embodiment of the present invention includes a robot control standard interface, a sensor related standard interface, a speech related standard interface, a sound related standard interface, a camera related standard interface, a face recognition related standard interface, or the like.

The interface described below uses a Java language based interface description method. However, the scope of the present invention is not limited thereto. For example, a ‘service.speech.TextToSpeech’ class, which is an interface described below, may be defined as a class named ‘service::speech::TextToSpeech’ in the case a C++ language. The case of other languages may be described by the name of ‘service_speech_TextToSpeech’.

The robot control standard interface according to the exemplary embodiment of the present invention includes a robot control related constant, a robot control related structure, a robot control related interface, a robot control related event, and robot control related capability.

As the robot control related constant, the following constant is defined. First, ‘service.robot.Direction’ is defined, which is a constant representing a direction at the time of requesting the movement or rotation of the robot. Second, ‘service.robot.HeadDirection’ is defined, which is a constant representing a head rotating direction of the robot. Third, ‘service.robot.SwingArmDirection’ is defined, which is a constant representing an arm rotating direction of the robot.

As the robot control related structure, the following structure is defined. First, ‘service.robot.BodyPosture’ is defined, which defines posture information of a robot. The posture information is defined as (x, y) coordinate values on a traveling map of a robot and a front angle on a map to which a body of a robot proceeds. Second, ‘service.robot.HeadPosture’ is defined, which defines a posture information of a robot head (or camera). The posture information is defined as a pan angle and tilt angle of a head.

As the robot control related interface, the following interface is defined. First, ‘service.robot.MoveWheel’ is defined, which is an interface defining a basic wheel motion that does not use a map of a robot. Second, ‘service.robot.MoveHead’ is defined, which is an interface defining a posture control of a robot head. The head of the robot is controlled by the pan angle and the tilt angle. The two values are defined by a service.robot.HeadPosture structure. Third, ‘service.robot.Navigation’ is defined, which moves the robot to a two-dimensional coordinate (x, y) on the traveling map and faces the body of the robot in a direction of an absolute angle defined on the map. Fourth, ‘service.robot.SwingArm’ is defined, which rotates the arm of the robot by a given angle (θ) in a given direction.

As the robot control related capability, the following capability is defined. First, ‘service.robot.RadiusTurnControl’ is defined, which defines a capability interface controlling the rotation of the robot while having a rotating radius. The capability may be obtained from a service.robot.MoveWheel object. Second, ‘service.robot.AbsoluteHeadControl’ is defined, which defines a capability interface rotating the head of the robot at an absolute angle. The head of the robot is controlled by the pan angle and the tilt angle. The pan represents the angle within which the head of the robot rotates left and right. If the angle is a positive value, the head of the robot means the left direction and if the angle is a negative value, the head of the robot means the right direction, based on the front which is 0. The tilt represents the angle within which the head of the robot rotates up and down. If the angle is a positive value, the head of the robot means the upper direction and if the angle is a negative value, the head of the robot means the lower direction, based on the front which is 0. The two values are integrally defined by a service.robot.HeadPosture structure. Third, ‘service.robot.AbsoluteHeadControl’ is defined, which defines the capability interface rotating the head of the robot at a relative angle. The head of the robot is controlled by the pan angle and the tilt angle. The pan represents the angle within which the head of the robot rotates left and right. If the angle is a positive value, the head of the robot means the left direction and if the angle is a negative value, the head of the robot means the right direction, based on a current head direction of the robot which is 0. The tilt represents the angle within which the head of the robot rotates up and down. If the angle is a positive value, the head of the robot means the upper direction and if the angle is a negative value, the head of the robot means the lower direction, based on the front which is 0. The two values are integrally defined by a service.robot.HeadPosture structure. Fourth, ‘service.robot.HeadPostureReader’ is defined, which defines the capability interface for obtaining a current rotating angle value of the robot head. The head rotation angle of the robot is controlled by the pan angle and the tilt angle, which is defined by the service.robot.HeadPosture structure.

The sensor related standard interface according to the exemplary embodiment of the present invention includes a sensor related service interface and a sensor related event.

As the sensor related service interface, the following interface is defined. First, ‘service.sensor.MotionSensor’ is defined, which defines the sensor interface sensing the motion within a predetermined range. When service.sensor.MotionSensor starts an operation, the motion sensing periodically starts. If the motion is sensed, a service.sensor.MotionDetected event is generated. Second, ‘service.sensor.TouchSensor’ is defined, which defines an interface of a touch sensor. When the touch sensor is operated and then, the touch is sensed, a service.sensor.TouchEvent event is generated.

As the sensor related event, the following event is defined. First, ‘service.sensor.MotionDetected’ is defined, which defines an event informing the motion sensed through service.sensor.MotionSensor. Second, ‘service.sensor.TouchEvent’ is defined, which defines an interface of an event informing when a touch is generated by the touch sensor.

The speech related standard interface according to the exemplary embodiment of the present invention includes a speech related interface, a speech related event, and speech related capability.

As the speech related service interface, the following interface is defined. First, ‘service.speech.TextToSpeech’ is defined, which defines an interface uttered through a speaker by synthesizing the sentence through a speech. Second, ‘service.speech.SpeechSensor’ is defined, which defines an interface of services managing a speech recognition session. Third, ‘service.speech.SpeechSession’ is defined, which defines a session object allocated through a speech recognition service service.speech. SpeechSensor.

As the speech related event, the following event is defined. First, ‘service.speech.SpeechReceived’ is defined, which defines an event generated as a speech recognition result.

As the speech related capability, the following capability is defined. First, ‘service.speech.SpeechVoiceControl’ is defined, which defines an interface uttered through a speaker by synthesizing the sentence through various voices. The sound related standard interface according to the exemplary embodiment of the present invention includes the sound related service interface and the sound related capability.

As the sound related service interface, the following interface is defined. First, ‘service.sound.SoundControl’ is defined, which defines a sound control interface and may provide capability such as service.sound.VolumeControl controlling a volume of a sound device, service.sound.MuteControl controlling a sound erasure of a sound device, or the like. Second, ‘service.sound.PcmPlayer’ is defined, which defines an interface reproducing pulse code modulation (PCM).

As the sound related capability, the following capability is defined. First, ‘service.sound.VolumeControl’ is defined, which defines the capability interface related to the volume control. Second, ‘service.sound.MuteControl’ is defined, which defines a service interface related to a sound erasure.

The camera related standard interface according to the exemplary embodiment of the present invention includes a camera control related constant, a camera control related structure, and a camera related service interface.

As the camera control related constant, the following constant is defined. First, ‘service.vision.ImageEncoding’ is defined, which defines an encoding method of an image.

As the camera control related structure, the following structure is defined. First, ‘service.vision.Resolution’ is defined, which defines a structure of image resolution. Second, ‘service.vision.ImageFormat’ is defined, which defines a structure of an image format. Third, ‘service.vision.Image’ is defined, which defines an interface of an image used for an image operation.

As the camera related service interface, the following interface is defined. First, ‘service.camera.Camera’ is defined, which is an interface opening a camera to capture the image.

The face recognition related standard interface according to the exemplary embodiment of the present invention includes a face recognition related constant, a face detection/recognition related service interface.

As the face recognition related constant, the following constant is defined. First, ‘service.geo.Point’ is defined, which defines eye positional information within a detected image. Second, ‘service.geo.Rectangle’ is defined, which defines face positional information within a detected image. Third, ‘service.vision.FaceId’ is defined, which defines the identifier information of the detected face. Fourth, ‘service.vision.FaceInfo’ is defined, which defines the identifier information of the detected face.

As the face detection/recognition related service interface, the following interface is defined. First, ‘service.vision.face.FaceDetector’, which is the interface of the face detection service, provides a function that converts the position of all the faces detected in the given images. When a face is not detected as a result of a normal face detection algorithm, ‘service.vision.face.FaceDetector’ provides a function of converting a rectangle arrangement having a length 0. Second, the interface of the face recognition service, that is, ‘service.vision.face.FaceRecognizer’ provides a function of adding the face recognition object face.

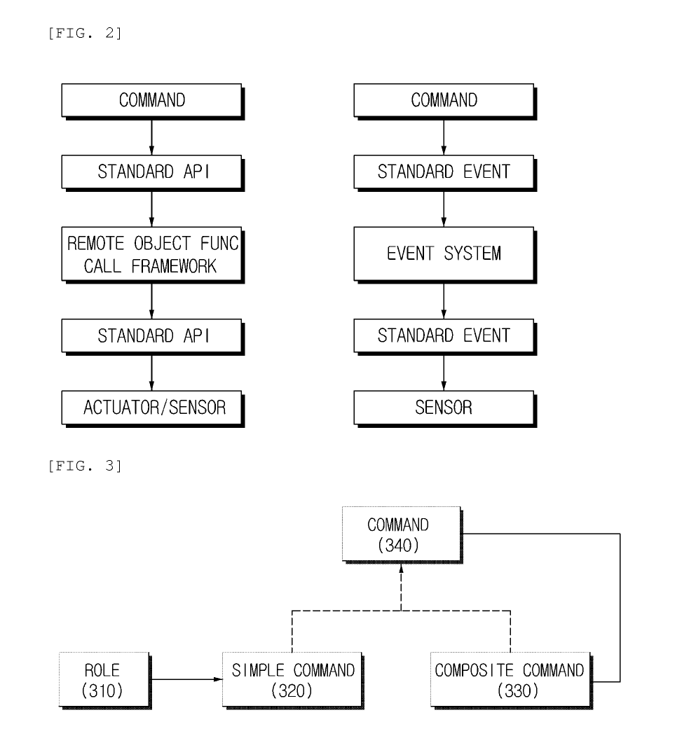

As shown in FIG. 2, the standard interface applies the command pattern to each of the standard API, thereby encapsulating the request of the user. As described above, it is possible to easily control the heterogeneous robot apparatuses in remote by allocating attribute values to the command rather than the detailed API for the user to control any robot by encapsulating the request of the user.

The general RPC model based standard interface uses the interconnected robot server, the plurality of robots, or the server/client model between the plurality of robots and the program requesting the service becomes a client and the program providing the services may be a server. Similar to a call of another normal or self procedure, the RPC is also the synchronization operation that the program requesting the service temporarily stops until the processing results of the remote procedure are returned. However, the use of the light process or the thread sharing the same address space, or the like, may be permitted to concurrently perform the several RPCs.

The policy repository 120 stores the standard event type in order to receive the sensor information transmitted from the sensing devices included in any robot 200, which communicates with each other. In this configuration, the command stored in the policy repository 120, which is a model abstracting the services, is configured as at least one service. The operation of the services are executed asynchronously. When all the services commonly end, the event is dispatched. The dispatched event includes several additional information, including the ending state of the services. Therefore, in order to recognize the state of the services, the information on the service state may be obtained by adding a callback function to the service. Some services dispatches separate events in order to transfer the information.

The command may include the following example. That is, the command may include ‘goto_landmark’, ‘goto_position’, ‘nop’, ‘onetime_face’, ‘onetime_speech’, ‘onetime_touch’, ‘play_media’, ‘play_pcm’, ‘speak’, ‘turn_head’, ‘turn_body’, ‘swing_arm’, ‘swing_arm_absolutely’, or the like.

In this case, the ‘goto_landmark’ command represents the command moving to the defined landmark and includes the landmark information to be moved and the posture correction information after arrival, or the like, the ‘goto_position’ command represents the command moving to the defined position and the position information to be moved and the posture correction information after arrival, or the like, the ‘nop’ command represents a command that does not perform any operation, the ‘onetime_face’ command represents a command using the face recognition sensor only once and includes the user information to be recognized and a face recognition permission lowest score, or the like, the ‘onetime_speech’ command represents a command using the speech recognition sensor only once and includes a recognition language list and a speech recognition permission lowest score, or the like, the ‘onetime_touch’ command represents a command using an access sensing sensor only once and includes a contact object list, or the like, the ‘play_media’ command represents a command reproducing a PCM file and includes reproduced PCM file information, or the like, the ‘turn_head” command represents a command moving a head and includes a horizontal moving angle, a vertical moving angle, or the like. The ‘turn_body’ command represents a command moving a body and includes an angle within which a body rotates and a direction in which a body rotates, or the like, the ‘swing_arm’ command represents a command relatively moving an arm based on the current position and includes information on an arm to be moved and information on scent to be moved, or the like, and the ‘swing_arm_absolutely’ command represents a command moving an arm at an absolute angle and includes posture correction information after arrival, or the like.

The policy repository 120 stores an operator for commands. The command may be executed using properties of each operator. The operator may execute the nested structure by including the command therein.

The operator may include the following example. That is, the operator may include ‘background’, ‘concurrent’, ‘delayed’, ‘periodic’, ‘sequential’, ‘timed’, or the like.

In this case, the ‘background’ operator represents an operator having a front/rear execution structure, wherein the front/rear may be provided with one command or an operator including a command. An object executed at the front has the higher priority and when the object executed at the front ends, the operator ends regardless of whether the object executed at the back ends. The ‘concurrent’ operator represents an operator that may concurrently execute several commands or an operator including a command and ends the operator when all the included commands or the operators end or the exceptional situations or the errors occur. The ‘delayed’ operator represents the operator executing the included commands or operators after a predetermined time lapses and may include only one command or an operator including a command. A ‘periodic’ operator represents an operator executed by a defined number of times at an execution period interval after the predetermined time lapses and may include only one command or an operator including a command. The ‘sequential’ operator represents an operator that sequentially executes several commands or operators including commands. The ‘timed’ operator (or, ‘timeout’ operator) represents an operator executed for a defined time and may include only one command or an operator including a command.

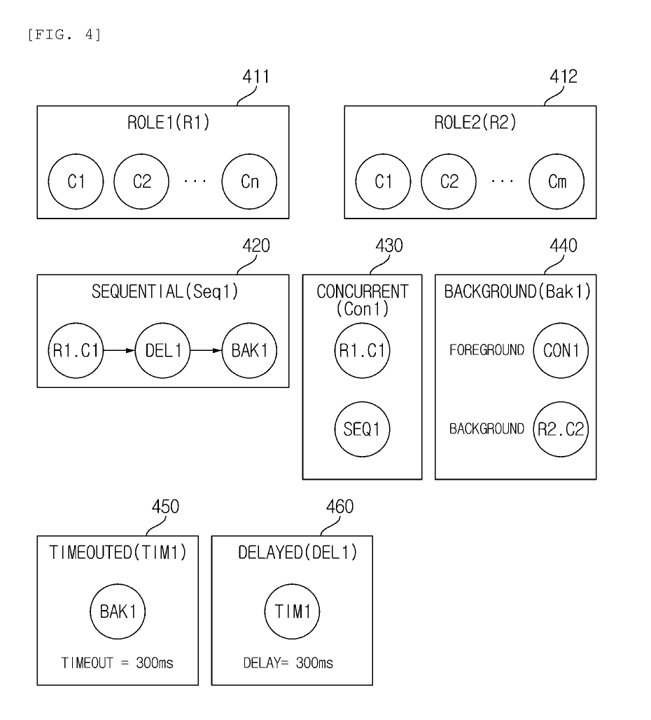

The command stored in the policy repository 120 depends on a composite pattern as shown in FIG. 3. That is, a command 340 has a tree structure and a simple command 320 that is a leaf node and a composite command 330 have a composite structure. All the simple commands 320 are each included in one role 310. In this case, the role 310 means a role of the apparatus participated for any collaboration and is represented by a set of commands necessary for performing the role, and are modeled by the user modeling the collaboration policy. That is, the role has the unique ID value differentiated from other roles by a logical combination of the commands and may have several command reference values. The command in the role represents the command reference value. In this case, the simple command is configured of a single command so as to perform the collaboration role and the composite command is configured of at least two commands so as to perform the collaboration role.

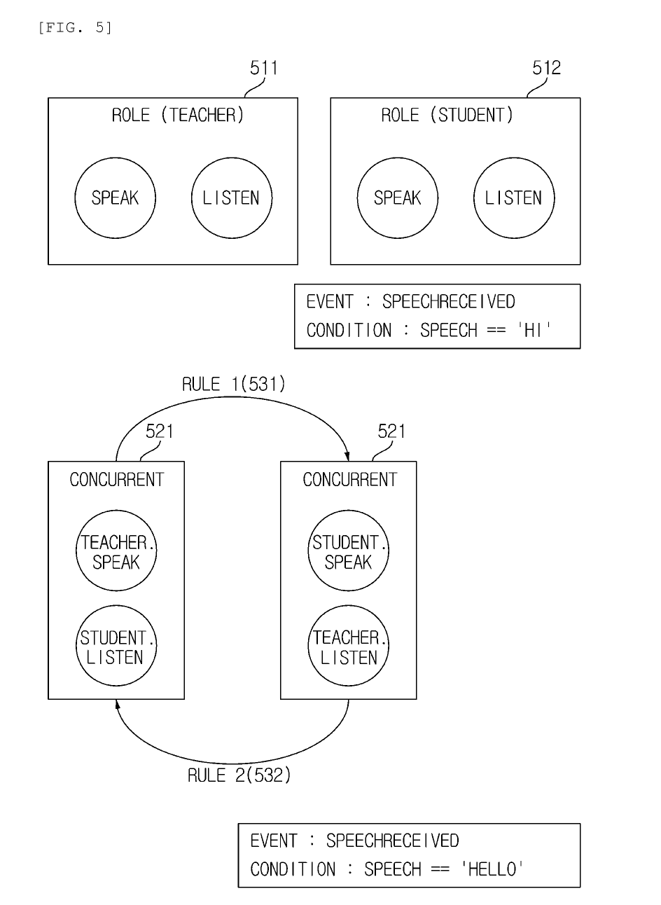

The type and the semantic of the composite command are as follows. That is, a sequential command 420 performs the included commands in sequence until the execution of the final command ends, a concurrent command 430 concurrently performs the included commands until the execution of all the commands ends, a unified background command 440 is executed until an execution of a foreground command and a background command concurrently starts and the foreground command ends. If the foreground command first ends, the execution of the background command is forcibly cancelled and a timeout command 450 performs the commands for the designated timeout time and if the timeout is generated, the execution of the command that is being performed is forcibly cancelled and a delay command 460 executes the command after the designated delay time. As shown in FIG. 4, the composite command may be variously combined by other composite commands.

FIG. 4 shows an example of the composite commands that may be combined, when two roles, role 1 (R1) 411 and role 2 (R2) 412 are modeled. In this case, the composite command includes at least one of a sequential command 420, a concurrent command 430, a unified background command 440, a timeout command 450, and a delay command 460.

In the exemplary embodiment, the role 1 (R1) 411 includes n simple commands C1, C2, . . . , Cn and the role 2 (R2) 412 includes m simple commands C1, C2, . . . , Cm.

The present drawing shows the example of the sequential command 420 and in the exemplary embodiment of the present invention, the C1 command of the role 1 (R1) 411 is executed and then, the delay command is executed.

Hereinafter, the timeout command is sequentially executed.

Meanwhile, the present drawing shows the example of the concurrent command 430 and in the exemplary embodiment of the present invention, the C1 command of the role 1 (R1) 411 is executed and at the same time, the sequential command is executed.

The present drawing shows the exemplary embodiment of the unified background command 440. In the exemplary embodiment of the present invention, the concurrent command that is the foreground command and the C2 command of the role 2 (R2) 412 that is the background command are concurrently performed, but when the concurrent command ends, the execution of the C2 command of the role 2 (R2) 412 is also cancelled.

The present drawing shows the exemplary embodiment of the timeout command 450 and in the present embodiment, the unified background command is performed for a predetermined time (300 ms in the exemplary embodiment of the present invention) and the unified background command is forcibly cancelled after the predetermined time lapses.

In the present drawing shows an exemplary embodiment of the delay command 460 and in the exemplary embodiment of the present invention, the timeout command is performed after the predetermined time (300 ms in the exemplary embodiment of the present invention) lapses.

The policy repository 120 stores the template model. The policy repository 120 stores the template model. In this case, the template stored in the policy repository 120 is a space that stores a command or a combination of commands to be more repeatedly used or executed in the specific pattern while the developer designs the policy.

The template may include the following example. That is, the template may include ‘command’, ‘background’, ‘concurrent’, ‘delayed’, ‘periodic’, ‘sequential’, ‘timed’, or the like.

Herein, the ‘command’ represents a role belonging thereto and the command including ID within the role, the “background’ represents a background within the template, the ‘concurrent’ represents a concurrent within the template, the ‘delayed’ represents delayed within the template, the ‘periodic’ represents periodic within the template, the ‘sequential’ represent sequential within the template, and the ‘timed’ represent timed within the template.

The policy repository 120 stores the model. In this case, the command and the operator within the model stored in the policy repository 120 is divided into two types.

One of them is commandable having a function as an execution unit and executable located within the operator. When the command model object is the commandable, it includes the executable information and when the operator model is the commandable, it includes only the commandable and when the operator model corresponds to the executable, it does not have the additional information. That is, the commandable represents the information representing the execution unit, it is applied both to the operator model and the command model. The executable represents the information executed by being located within the operator and is applied to only the command model. The branch is generated between the command model or the operator model. Herein, the case in which the branch is generated corresponds to the case in which the command or the operator describing the branch satisfies the events in the operator. When the branch is generated, the data necessary for characteristics may be stored.

The branch may include the following example. That is, the branch may include ‘rule’, ‘assign’, ‘transition’, or the like.

Herein, ‘rule’ represents a model including the event and the condition information and when all of the conditions with and the event are satisfied, the operation corresponding to the assign is performed. The ‘assign’ represents the model for sharing the data at the time of the branched timing and var of the assing is reference variables of property and the value becomes a reference value. The ‘transition’ represent a model including qnsrl information and has information on a branched place where the branch is made orand information on thea destination Similar to the XSD model, a single branch may include several rules and has assing objects separate from the assing objects within the rule. The model may be a policy model designed in the PMT.

The policy repository 120 stores an engine model. Herein, the engine model stored in the policy repository 120 means an application model in which the policy model designed in the PMT is actually executed by using any client information by a compile process.

The application model follows a statechart structure and an example of the important data model may include ‘StateChart’, ‘State’, ‘Command’, ‘Rule’, or the like.

In this case, the ‘StateChart’ represents an application model actually executing the engine model. The ‘State’ represents the execution unit model within StateChart, the state is configured of ‘Entry’, ‘Rules (Handle Event)’, and ‘Exit’ and the command model object described in the policy model is located within Entry after the compile process is performed. The ‘Command’ represents the execution model within the State and is executed based on the added Role information via the compile process. The Role information is added as the command model object via the compile process. When the command manager entries the specific State, the command manager it receives the command information existing in the Entry of the State to acquire the specific client (or, specific terminal) from dynamic device match marker and then, acquire the service from the specific client, thereby returning the executable object as State. The ‘Rule’ represents the model having information on the transition between the States, the State may include several Rule objects, each Rule object includes the separate transition destination, the Assing object, and the event, and the condition information corresponding thereto. When the event is transferred during the executed Stateevent and, after the event and the condition described in each Rule object are compared to be is transited to the destination described in the Rule object.

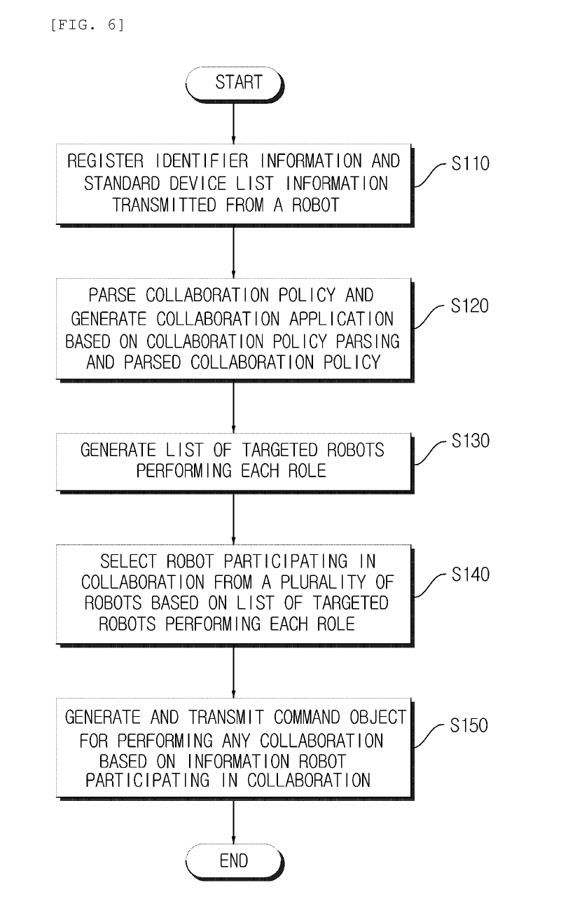

The policy repository 120 stores the collaboration policy model including a role, a command, a transition and the a transition rule. Herein, the collaboration policy model may be represented by a command transition diagram as shown in FIG. 5. The transition between the commands is performed when satisfying the transition rule, the transition rule includes the event and the condition. Herein, the transition rule represents the rule generating the transition converting the collaboration role of the command execution.

When the execution of all the commands ends, the predetermined command ending event (for example, “CommandFinished Event”) is generated. In the case of the command encapsulating the sensing device as shown in FIG. 2, the event received from the sensing device is generated before the ending.

According to the exemplary embodiment of the present invention, the collaboration policy modeling in FIG. 5 is as follows. Herein, the collaboration policy includes a scenario, a role, a command, a transition rule, or the like. That is, the scenario corresponds to a case in which a teacher robot and a student robot repeat simple conversation with each other. First, when the teacher robot speaks ‘Hi’, the student robot recognizes the speech. Thereafter, when the student robot speaks “Hello”, the teacher robot recognizes the speech and then, the teacher robot speaks ‘Hi’ again. The role includes a teacher 511 and a student 512 and includes speak and listen. The command concurrently composites ‘teacher.speak’ and ‘student.listen’ and includes a ‘command 1’ 521 for the student robot to recognize the speech when the teacher robot speaks by concurrently compositing ‘teacher.speak’ and ‘student.listen’ and a concurrently composites ‘student.speak’ and ‘teacher.listen’ and includes ‘command 2’ 522 for the teacher robot to recognize it the speech when the student robot speaks by concurrently compositing ‘student.speak’ and ‘teacher.listen’ and includes. The transition rule includes a transition rule 1 531 transiteding from the command 1 521 to the command 2 522 when a predetermined ‘SpeechReceived’ event is transferred from ‘student.listen’ and the recognized speech recognition result is ‘Hi’ and a transition rule 2 532 transiteding from the command 2 522 to the command 1 521 when a predetermined ‘SpeechReceived’ event is transferred from ‘teacher.listen’ and the recognized speech recognition result is ‘Hello’.

The policy repository 120 stores programs and data needed to operate the robot server 100. The policy repository 120 may include at least one storage medium of a flash memory type, a hard disk type, a multimedia card micro type, a card type memory (for example, SD or XD memory, or the like), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM).

A policy parser unit 130 according to the exemplary embodiment of the present invention reads any collaboration policy prestored in the policy repository 120 and parses the read collaboration policy.

A policy factory 140 according to the exemplary embodiment of the present invention generates collaboration application that may be executed by the policy engine 150 based on the collaboration policy parsed from the policy parser unit 130.

The policy engine 150 according to the exemplary embodiment of the present invention performs the collaboration function based on the collaboration application generated by the policy factory 140.

A role registry unit 160 according to the exemplary embodiment of the present invention registers at least one role modeled in the collaboration policy and at least one command type needed to perform each role during in a process of parsing the collaboration policy by the policy parser unit 130.

An intermediary unit 170 according to the exemplary embodiment of the present invention binds any one (or, at least one robot) of the plurality of actual robots 200 to each role included in the generated collaboration applications. That is, the intermediary unit 170 performs a match making between a plurality of roles and a plurality of robots 200, for each role corresponding to a command consumer requiring commands to perform a role and a plurality of robots 200 corresponding to a command provider providing commands. The intermediary unit 170 queries (matching) an identifier and a standard device list of a robot registered in the robot registry unit 110 and at least one role registered in the role registry unit 160 and generates and outputs the list of the targeted robots capable of performing each role based on the query results.

The command manager 180 according to the exemplary embodiment of the present invention binds each role to the plurality of robots 200, respectively, based on the list of the targeted robots capable of performing each role on at least one role included in the collaboration application output from the intermediary unit 170, thereby selecting the robot participating in the collaboration.

The command manager 180 includes a command factory 181 and a command container 182.

When the command manger 180 selects all the robots participating in the collaboration, the commands represented by ‘role.command’ is replaced with ‘robot.command’ in the collaboration model. That is, the command manger 180 determines whether any robot executes the corresponding command through the provided standard device, generates the command object bound with the standard device of the targeted robot corresponding to any role through the command factory 181 for each commands represented by each command transition diagram, and performs the generated command object.

The command factor 181 according to the exemplary embodiment of the present invention selects the robot participating in the collaboration, generates each command object, and executes the generated command object.

The command container 182 according to the exemplary embodiment of the present invention stores various pieces of information is selected and generated by the command factory 181 and stores the generated various information.

The communication unit 190 according to the exemplary embodiment of the present invention serves to transmit each information on the role and the command according to the collaboration applications to each robot. The communication unit 190 serves to receive the information on the identifiers of each robot and the information on the standard device list included in each robot from each robot.

The plurality of robots 200 according to the exemplary embodiment of the present invention may transmit and receive any information/data to and from the homogeneous and/or heterogeneous server and/or the robot by using the standard interface based on the general RPC model described in the present specification based on the homogenous and/or heterogeneous communication protocol.

The robot 200 includes the robot manager that manages and controls the standard devices included in the corresponding robot.

The plurality of robots 200 each includes various devices that execute various functions. That is, the robot 200 includes an input unit 210, an image input unit 220, a sensing unit 230, a policy repository unit 240, a driving unit 250, a communication unit 260, a power supply unit 270, a display 280, a speaker 290, and a robot manager 300.

Hereinafter, the driving unit 250, the display 280, the image input unit 220, the sensing unit 230, the speaker 290 are referred to as an execution device (execution unit). Herein, the execution device (execution unit) means a device that performs commands according to the command of the robot server. When the command is speech, the execution device may be the speaker 290. When the command is an image display, the execution device may be the display 280. When the command is a motion of the robot, the execution device may be the driving unit 250. When the command is an image photographing, the execution device may be the image input unit 220. When the command is the position sensing of the robot, the execution device may be the sensing unit 230.

The input unit 210 according to the exemplary embodiment of the present invention receives the signals corresponding to the information input by the user and may use various devices such as a key pad, a dome switch, a jog shuttle, a mouse, a stylus pen, a touch screen, a touch pad (constant voltage/constant current), a touch pen, or the like.

The input unit 210 may include at least one mike (not shown) for receiving audio signals. The input unit 210 receives any acoustic signal (or, acoustic information) and/or a speech signal of a user (or, speech information of a user) through the mike.

The mike receives external acousticspeech signals (including speech (speech signal or speech information) of a user) from the microphone in a call mode, a recording mode, a speech recognition mode, an image conference mode, an image calling mode, or the like, to be process the ed external speech signals as to the electrical speech data. The processed speech data (including electrical speech data corresponding to, for example, an acoustic signal, a speech signal, an audio signal of TV) may be output through the speaker 290 and or converted or output into transmittable form to the external terminal through the communication unit 260.

The image input unit 220 according to the exemplary embodiment of the present invention images the image information by the control of the robot manager 300. The image input unit 220 includes an image sensor such as a camera, or the like, that is installed at a predetermined position (top, side, or the like) of the robot 200. The camera processes an image frame such as a still image (including a gif type, a jpeg type, or the like) or a moving picture (including a wma type, an avi type, an asf type, or the like) obtained by an image sensor (camera module or camera). That is, the corresponding image data obtained by the image sensor are encoded to meet each standard according to a codec. The processed image frame may be displayed on a display 280 by a control of the robot manager 300. As an example, the camera photographs an object (or a subject) and outputs the video signal corresponding to the photographed image (subject image). The image frame processed by the camera is stored in the policy repository 240 or may be transmitted to any external terminal communicating with the communication unit 260.

The sensing unit 230 according to the exemplary embodiment of the present invention is provided at the predetermined position of the robot 200 (for example, side, or the like) and senses (or detects) an object (or, obstacles) existing within the predetermined distance of the robot 200 during traveling or non-traveling.

The sensing unit 230 includes a sensor that detects a position of an obstacles and a distance between the obstacles through the received signals by transmitting/receiving the signals from a radio frequency (RF) sensor, an infrared sensor, a supersonic sensor, or the like, or a collision sensor that senses obstacles by the collision with the obstacles, or the like.

The policy repository 240 according to the exemplary embodiment of the present invention stores programs and data, or the like, required to operate the robot 200. The policy repository 240 may include at least one storage medium of a flash memory type, a hard disk type, a multimedia card micro type, a card type memory, a magnetic memory, a magnetic disk, an optical disk, a RAM, an SRAM, a ROM, an EEPROM, and a PROM.

The policy repository 240 stores a list of each device included in the each robot 200, that is, a standard device list. The policy repository 240 stores the identifier information which is the information capable of identifying each robot 200.

Meanwhile, the policy repository 240 according to the exemplary embodiment of the present invention may store the collaboration policy model according to the exemplary embodiment. In this case, the plurality of robots 200 uses the stored collaboration policy model to perform the collaboration operation.

The driving unit (actuator) 250 according to the exemplary embodiment of the present invention includes at least one wheel and drives at least one wheel by the driving unit such as a motor, or the like.

The driving unit 250 performs a traveling operation such as movement, stop, direction conversion, or the like, by a control of a robot control 300.

The driving unit 250 may be connected to sensors such as an encoder, or the like.

The communication unit 260 according to the exemplary embodiment of the present invention may perform the interconnection with the robot server 100 or any robot 200 by a wired/wireless communication type. Herein, the wireless network may include a module for radio Internet connection or a module for short range communication. In this case, an example of the radio Internet technology may include a wireless LAN (WLAN), a wireless broadband Wibro, a Wi-Fi, a world interoperability for microwave access (Wimax), a high speed downlink packet access (HSDPA), or the like. An example of the short range communication technology may include a Bluetooth, a zigbee, an ultra wideband (UWB), radio frequency identification (RFID), infrared data association (IrDA), or the like. A wired communication technology may include universal serial bus (USB) communication, or the like.

When the communication unit 260 communicates with any robot server 100 or any robot 200 by the control of the robot manager 300, the communication unit 260 provides the list of the standard devices provided in the corresponding robot pre-stored in the policy repository unit 240 and the information on the identifier of the robot to any robot server 100. The communication unit 260 receives the information on the role of the robot according to the collaboration application from the robot server and the information on the command to be performed by the robot for the corresponding role.

The power supply unit 270 according to the exemplary embodiment of the present invention stores (or charges) power supplied from the external power supply device. The power supply unit 270 supplies power to each component that is provided in the robot 200. The power supply unit 270 may include a battery, a charger, a rectifier, or the like.

The power supply unit 270 includes a battery configured of a single device or a plurality of batteries formings one pack (battery pack). When the power supply unit 270 includes a plurality of batteries, the plurality of batteries are connected to each other in series and at least one safety switch may be included between the plurality of batteries.

The power supply unit 270 may receive power by an external power supply device and a wired/wireless charging type. That is, the power supply unit 270 is directly connected to the external power supply device by components such as a power socket or the power supply unit 270 and the external power supply device each includes the transmitting/receiving units, wherein and the power supply 270 may be charged by any one of a magnetic resonance coupling method, an electromagnetic induction method, and a radiowave method between the transmitting/receiving units.

That is, the power supply 270 and the external power supply device may be configured to be charged in wireless and when being charged in wireless, the configuration of the receiving unit and the transmitting unit is easily designed by those skilled in the art to perform the function.

The display 280 according to the exemplary embodiment of the present invention is installed at the predetermined position (side, top, or the like) of the robot 200 and displays various information (including image photographed by the image input unit 220) generated by the robot manger 300.

The display 280 may include at least one of a liquid crystal display (LCD), a thin film transistor-liquid crystal display (TFT LCD), an organic light-emitting diode display (OLED), a flexible display, a field emission display (FED), and a 3D display.

At least two displays 280 may be present according to the implementation type of the robot 200. For example, the plurality of displays may be disposed to be spaced apart from each other or may be integrally disposed on one surface (co-plane) of in the robot.

When the display 280 includes a sensor sensing the touch operation, the display 280 may be used the input device in addition to the output device. That is, when the touch sensor such as the touch film, the touch sheet, the touch pad, or the like, is provided at the display 280, the display 280 may be operated as the touch screen.

The speaker 290 according to the exemplary embodiment of the present invention outputs the speech information included in various information generated by the robot manager 300.

The speaker 290 outputs any speech recognition results by the control of the robot manager 300.

If the robot manager (control unit) 300 according to the exemplary embodiment of the present invention communicates with any robot server 100, the robot manager 300 performs a controls to transmit the list of the devices included in the robot 200 pre-stored in the policy repository 240, that is, the standard device list to the robot server 100 through the communication unit 260.

The robot manager 300 receives the command object generated by any robot server 100 through the communication unit 260 and performs any role based on the received command object. That is, the robot manager 300 performs a control to drive the execution device based on the command object.

That is, referring to FIG. 5, when the robot manager 300 (for example, corresponding to the teacher robot) performs the collaboration policy with any robot (for example, corresponding to the student robot), the robot manager outputs the speech message called ‘Hi’ through the speaker 290, based on the command object received from the robot server 100. The robot manager 300 is converted into the speech recognition state based on the additional command object received from the robot server 100, receives the message (for example, ‘hello’) output from any robot, and performs the speech recognition function for the received message using the speech recognition algorithm pre-stored in the policy repository 240. The robot manager 300 outputs the message (for example, ‘Hi’) pre-stored in the policy repository 240 through the speaker 290 when the speech recognition result (‘Hello’) is identical with the predetermined message (for exempla, ‘Hello’). The robot manager 300 concurrently composites ‘teacher.speak’ and ‘student.listen’ based on the command object transmitted from the robot sever 100 and includes a ‘command 1’ 521 for the student robot to recognize the speech when the teacher robot speaks by concurrently compositing ‘teacher.speak’ and ‘student.listen’ based on the command object transmitted from the robot sever 100 and includes and concurrently composites ‘student.speak’ and ‘teacher.listen’ and includes a ‘command 2’ 522 for the teacher robot to recognize it when the student robot speaks by concurrently compositing ‘student.speak’ and ‘teacher.listen’.

According to the exemplary embodiment of the present invention, the function of the robot server 100 may be configured so that any robot of the plurality of robots 200 performs the function of the corresponding robot server 100. That is, when the plurality of robots 200 configures the network system such as the ad-hoc network, the sensor network, or the like, any robot of the plurality of robots 200 configuring the network system may be configured to perform the function corresponding to each component included in the robot server 100.

FIG. 6 is a diagram showing a flow chart describing a method for controlling a robot system according to an exemplary embodiment of the present invention.

Hereinafter, the exemplary embodiment of the present invention will be described with reference to FIGS. 1 to 6.

First, when the robot registry unit 110 communicates with the plurality of robots 200 through any wired/wireless network, the robot registry unit 110 receives the identifier information and the standard device list information transmitted from each robot 200 and registers/stores the identifier information and the standard device list information of the corresponding received robot (S110).

The policy parser unit 130 parses any collaboration policy pre-stored in the policy repository 120 and the policy factory 140 generates the collaboration application capable of performing the policy engine 150 based on the parsed collaboration policy.

When the policy parser unit 130 parses the collaboration policy, the role registry unit 160 registers at least one modeled role and at least one command type necessary to perform each role (S120).

The intermediary unit 170 queries (matches) the standard device of the robot performing each role based on the identifier information of the plurality of robots registered in the robot registry unit 110 and the standard device list information and at least one role registered in the role registry unit 160 and generates the list of the targeted robots performing each role based on the query results (S130).

The command manager 180 binds each role to any one of the plurality of robots 200 based on the list of the targeted robots performing each role generated from the intermediary unit 170 and selects the robots participating in the collaboration from the plurality of robots 200 (S140).

The command manager 180 generates the command object for performing any collaboration based on the information of the robot participating in any selected collaboration and transmits the generated command object to the corresponding robot. The corresponding robot receiving the command object performs any function using the specific standard device included in the corresponding robot based on the received command object (S150).

The robot system and the method for controlling the same according to the exemplary embodiment of the present invention interconnects the plurality of homogeneous and/or heterogeneous robots to be applied to fields performing the collaboration function.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A robot server for controlling collaboration of at least one robot, comprising:
a policy repository storing a collaboration policy model including a collaboration role of the robot and a command system configured of a simple command configured of a single command so as to perform the collaboration role and a composite command including at least one simple command; and
a communication unit transmitting information on the collaboration role to be allocated to at least one robot and information on the simple command or the composite command to be allocated according to the collaboration role to the at least one robot.

2. The robot server of claim 1, wherein the composite command includes at least one of:
a first command allocating a sequence to at least two commands;
a second command simultaneously performing at least two commands;
a third command simultaneously performing a foreground command and a background command, and automatically forcibly canceling the background command when the foreground command is first ended;
a fourth command performing a command only for a specified time-out time; and
a fifth command performing a command after a specified delay time.

3. The robot server of claim 1, wherein the collaboration policy model further includes a transition rule generating transition changing the collaboration role of command performance.

4. The robot server of claim 1, further comprising a policy parser parsing the collaboration policy model stored in the policy repository.

5. The robot server of claim 14, further comprising a policy factory generating a collaboration application based on the collaboration policy model parsed from the policy parser.

6. The robot server of claim 1, further comprising a robot registry unit registering identifier information and standard apparatus list information each transmitted from the robot.

7. The robot server of claim 6, further comprising a role registry unit registering at least one collaboration role modeled in the collaboration policy and at least one kind of command required for performing each collaboration role.

8. The robot server of claim 7, further comprising an relay unitintermediary unit searching a standard apparatus to perform each collaboration role based on a plurality of robot identifier information and standard apparatus list information registered in the robot registry unit and at least one collaboration role registered in the role registering unit and generating a list of target robots to perform each collaboration role based on the search result.

9. The robot server of claim 8, further comprising a command manager selecting a robot participating in the collaboration among the plurality of robots based on the list of the target robots to perform each collaboration role generated from the relay unitintermediary unit and generating a command object for controlling the selected robot.

10. A robot controlled by collaboration control of a robot server, comprising:
a communicating unit receiving corresponding role information on the collaboration and information a corresponding command related to a role for the collaboration that are generated based on a collaboration policy model including a collaboration role of the robot stored in the robot server and a command system configured of a simple command configured of a single command so as to perform the collaboration role and a composite command including at least one simple command; and
a performing unit performing actions corresponding to the corresponding role and the corresponding command.

11. The robot of claim 10, wherein the performing unit is a speaker when the corresponding command according to the corresponding role is a command for speech.

12. The robot of claim 10, wherein the performing unit is a driver when the corresponding command according to the corresponding role is a command for movement.

13. The robot of claim 10, wherein the performing unit is a display when the corresponding command according to the corresponding role is a command for image display.

14. The robot of claim 10, further comprising a robot manager performing a control to transmit identifier information of the robot and standard apparatus list information of the robot to the robot server.

15. A method for controlling at least one robot, comprising:
receiving, from at least one robot used for a predetermined collaboration, identifier information of the robot and standard apparatus list information of the robot;
extracting a corresponding role of the robot used for the predetermined collaboration and a command according to the corresponding role from a collaboration policy model;
selecting a corresponding robot among the at least one robot based on the identifier information of the robot, the standard apparatus list information of the robot, the corresponding role of the robot, and the command according to the corresponding role; and
transmitting information on the role of the robot and information on the command according to the role to the selected corresponding robot.

16. The method of claim 15, wherein the collaboration policy model including a role of the at least one robot and a command system configured of a simple command configured of a single command so as to perform the role and a composite command including at least one simple command.

17. The robot server of claim 15, wherein the composite command includes at least one of:
a first command allocating a sequence to at least two commands;
a second command simultaneously performing at least two commands;
a third command simultaneously performing a foreground command and a background command, and automatically forcibly canceling the background command when the foreground command is first ended;
a fourth command performing a command only for a specified time-out time; and
a fifth command performing a command after a specified delay time.

18. A method for controlling at least one robot, comprising:
receiving corresponding role information on the collaboration and information a corresponding command related to a role for the collaboration that are generated based on a collaboration policy model including a collaboration role of the robot stored in the robot server and a command system configured of a simple command configured of a single command so as to perform the collaboration role and a composite command including at least one simple command; and
performing actions corresponding to the corresponding role and the corresponding command.

19. The method of claim 18, further comprising transmitting identifier information of the robot and standard apparatus list information of the robot to the robot server.
